(19) United States
(12) Patent Application Publication
(10) Pub. No.: US 2004/0114938 A1
(43) Pub. Date: Jun. 17, 2004

(54) Wavelength locking package employing a stacked dielectric filter

(76) Inventor: James Edward Nering, Summit, NJ (US)

Correspondence Address: JAMES E. NERING, 28 CROMWELL PARKWAY, SUMMIT, NJ, 07901, US

(21) Appl. No.: 10/731,394

(22) Filed: Dec. 8, 2003

Related U.S. Application Data
(60) Provisional application No. 60/431,929, filed on Dec. 9, 2002.

(51) Int. Cl. H04B 10/12

(52) U.S. Cl. 398/149

(57) ABSTRACT

The present invention provides, in one embodiment, a wavelength locking package comprising a stacked dielectric filter. The filter's light repeating transmission profile, comprising a positive and negative slope, facilitate locking the laser at any one of a plurality of wavelengths. Such wavelength locking packages may be advantageously used in optoelectric telecommunication systems.

### TECHNICAL FIELD OF THE INVENTION

The present invention is directed, in general, to a laser stabilization device, and a method of fabrication thereof, that includes a stacked dielectric filter and facilitates the stabilization of the laser's output at any one of a plurality of wavelengths.

### BACKGROUND OF THE INVENTION

Optoelectronic devices, such as lasers for use in optical communication systems, have to meet stringent requirements. At the same time, there also is a desire to increase telecommunication capacity optical communication systems via, for example, the use of dense wavelength division multiplexing (DWDM) laser packages in fiber optic network-based systems. The operation of these packages at increasingly reduced wavelength spacing between communication channels requires increasingly sophisticated methods of wavelength stabilization or locking at multiple wavelengths.

In a typical laser wavelength locking package, the output wavelength of a laser is altered by adjusting the operating temperature of the laser, by changing the power to a thermoelectric cooler (TEC) that is thermally coupled to the laser. The feedback signal to increase or decrease operating temperature is usually based on monitoring changes in the relative intensity of a signal corresponding to a portion of light passing from the laser through an etalon to a photodetector, as compared to a reference signal. Using this approach, laser output stabilities of about +2.5 GHz, for 50 GHz and 100 GHz channel spacings, have been attained.

The use of etalons in laser wavelength locking packages remains problematic, however. An etalon's light transmission profile has a periodic characteristic, as revealed, for example, by a plot of transmittance intensity versus wavelength. The periodicity of the etalon's transmission profile, in turn, depends on the refractive index of the materials used to make reflective surfaces in the etalon, as well as the distance between the reflective surfaces. Producing etalons with a particular desirable transmission profile is difficult, because a slight change in the distance between reflective surfaces has a large effect on the profile. As a result, there are low manufacturing yields associated with producing such etalons, thereby increasing costs of etalon-based laser tuning packages.

Another problem with etalons is that only light transmission profiles having a sinusoidal function are possible. Therefore, the transmittance intensity may not vary sufficiently at the peaks or troughs in the profile to provide an adequate feedback signal for controlling the wavelength of light emitted by the laser.

In addition, the operating characteristics of etalons are highly temperature dependent. In particular, temperature induced changes in the index of refraction of the reflective surfaces comprising the etalon can cause a change in the distance between peaks of maximum transmittance or the operating wavelength range of the etalon. Even a ˜1° C. change in the temperature of an etalon, for example, can change the operating range of an etalon by more than 5 GHz. In the course of controlling the output wavelength of a laser via a TEC, however, the change in temperature of an etalon in the package can be as much as ˜10° C.

In these circumstances, shifts in the operating range of the etalon can cause a spurious feedback signal to increase or decrease operating temperature of the laser, thereby causing the laser to lose its lock or to operate at an undesired wavelength. Consequently, the temperature of an etalon must be precisely controlled to prevent changes in the physical dimensions of the etalon due to thermal expansion or contraction. This, in turn, may necessitate the use of a separate chamber to house the etalon and control the etalon's temperature, thereby increasing the expense and complexity of etalon-containing laser tuning packages. Moreover, because the distance between reflective surfaces in the etalon depends in part on the angle of the laser being tuned, it is necessary to accurately align and maintain the etalon's position relative to the laser. A separate housing for the etalon exacerbates the problems associated with alignment.

As an alternative to etalons, optical filters have been used to monitor and provide feedback for tuning in single channel laser applications. Filters are advantageous because their light transmission profiles are less temperature sensitive than etalons. In addition, a filter can replace the function served by an etalon with minimal alterations in the design of the laser package. By performing active alignment, that is, adjusting the position of the filter relative to the laser, the desired output wavelength of the laser may be selected and controlled using the same feedback mechanism described above for etalon-containing packages.

There are limitations, however, in the use of filters to monitor and stabilize the wavelength or frequency of light output by the laser. It is necessary for there to be a sufficient change in the intensity of the light signal passing through the filter as a linear function of a change in the frequency of light emitted by the laser. Presently used filters have a monotonic light transmission profile, whereby, for example, the change in the transmittance of light with frequency increases linearly over a spectral range of about 50 GHz. The application of such filters is therefore limited by the extent of change in intensity per unit change in frequency over the frequency range of interest. For example, in current telecommunication applications, at least a ˜0.5% change in the intensity of the signal per 1 GHz change in light output by the laser is required. As such, optical filters have been used only for locking lasers that operate at only one wavelength within a 50 GHz frequency band.

Filters comprising stacks of dielectric materials have been used as gain flattening filters in optical amplifier applications. Gain flattening filters, however, do not have a regular or repeating transmission profiles. Rather, the transmission profile of gain flattening filters are designed to be the compliment of the irregular aperiodic gain profile of a light source, such as an erbium-doped laser.

Accordingly, what is needed in the art is a wavelength locking package that does not exhibit the limitations of the prior art.

### SUMMARY OF THE INVENTION

To address the above-discussed deficiencies of the prior art, the present invention provides a wavelength locking package comprising a stacked dielectric filter having a repeating transmission profile that comprises a positive slope and a negative slope.

In another embodiment, the present invention provides a method of fabricating a wavelength locking package. The method comprises providing a base, and locating a stacked dielectric filter, having the repeating transmission profile as described above, on the base. The method further includes locating a photodetector on the base material, such that the photodetector is optically coupled to the stacked dielectric filter.

Still another embodiment is an optoelectronic communication system. The system comprises a laser, a wavelength locking package optically coupled to the laser, and an optical modulator coupled to the laser. The laser is capable of emitting coherent light at a plurality of wavelengths. The stacked dielectric filter, having a repeating transmission profile as described above, is capable of providing a signal to cause the laser to emit the coherent light at one of the pluralities of wavelengths. The optical modulator is capable of encoding information into the coherent light.

The foregoing has outlined preferred and alternative features of the present invention so that those of ordinary skill in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the scope of the invention.

### BRIEF DESCRIPTION OF THE DRAWINGS

The invention is best understood from the following detailed description when read with the accompanying FIGUREs. It is emphasized that in accordance with the standard practice in the optoelectronics industry, various features may not be drawn to scale. In fact, the dimensions of the various features may be arbitrarily increased or reduced for clarity of discussion. Reference is now made to the following descriptions taken in conjunction with the accompanying drawings, in which:

FIG. 1 illustrates a sectional view of an exemplary wavelength locking package of the present invention;

FIG. 2 illustrate exemplary (A) sinusoidal; (B) sawtooth; and (C) triangular transmission profiles for a stacked dielectric filter that could be included in a wavelength locking package of the present invention;

FIG. 3 illustrates exemplary transmission profiles for a wavelength locking package of the present invention having two stacked dielectric filters;

FIG. 4 illustrates by flow diagram, a method for fabricating a wavelength locking package according to the principles of the present invention;

FIG. 5 illustrates an optoelectronic system that includes the wavelength locking package constructed according to the principles of the present invention; and

FIG. 6 illustrates a predicted seven-peak sinusoidal transmission profile for a periodic stacked dielectric filter, that could be included in a wavelength locking package of the present invention.

### DETAILED DESCRIPTION

The present invention recognizes for the first time the advantages of using a stacked dielectric filter for stabilizing multiple output channels of a laser. Unlike the monotonic transmission profile of previously used filters, or the aperiodic transmission profiles of gain flattening filters, the stacked dielectric filter of the present inventions has a repeating transmission profile.

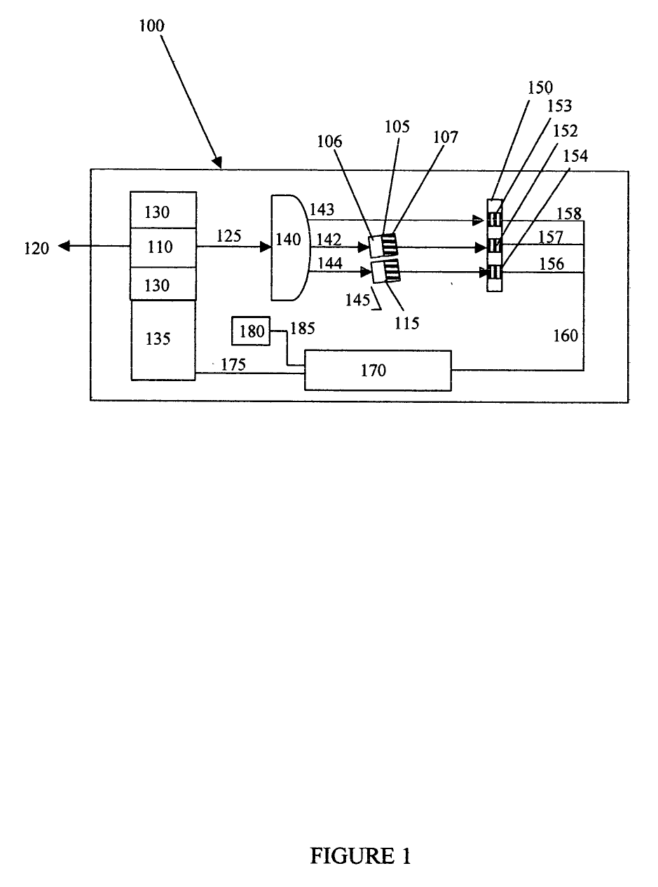

FIG. 1 illustrates a sectional view of one embodiment of the present invention, an exemplary wavelength locking package 100. The wavelength locking package 100 comprises a stacked dielectric filter 105 having a repeating transmission profile that comprises a positive slope and a negative slope. The term transmission profile as used herein, refers to the function that defines the relationship between the transmittance of light as a function of the wavelength of light. The term transmittance, as used herein, is defined as the fraction of radiant light intensity transmitted by the filter 105 as compared to light not passing through the filter 105. The term slope as used herein, refers to the change in transmittance of light passing through the filter 105 per unit change in the frequency of the light passing through the filter 105.

The stacked dielectric filter's transmission profile allows the filter 105 to receive coherent light from a laser 110, and thereby provide a signal to lock the laser's output to any one of a plurality of wavelengths over the broad spectral range of wavelengths that the laser 110 is capable of emitting. For the purposes of the present invention, a laser 110 is defined as any device capable of emitting coherent light at a plurality of wavelengths. The coherent light may comprise electromagnetic radiation at a wavelength or band of wavelengths of light that oscillate at a particular frequency or band of frequencies characteristic of the laser 110. A particular advantage in using such stacked dielectric filters 105 is that a much broader range of types of transmission profiles can be fabricated, as compared to etalons.

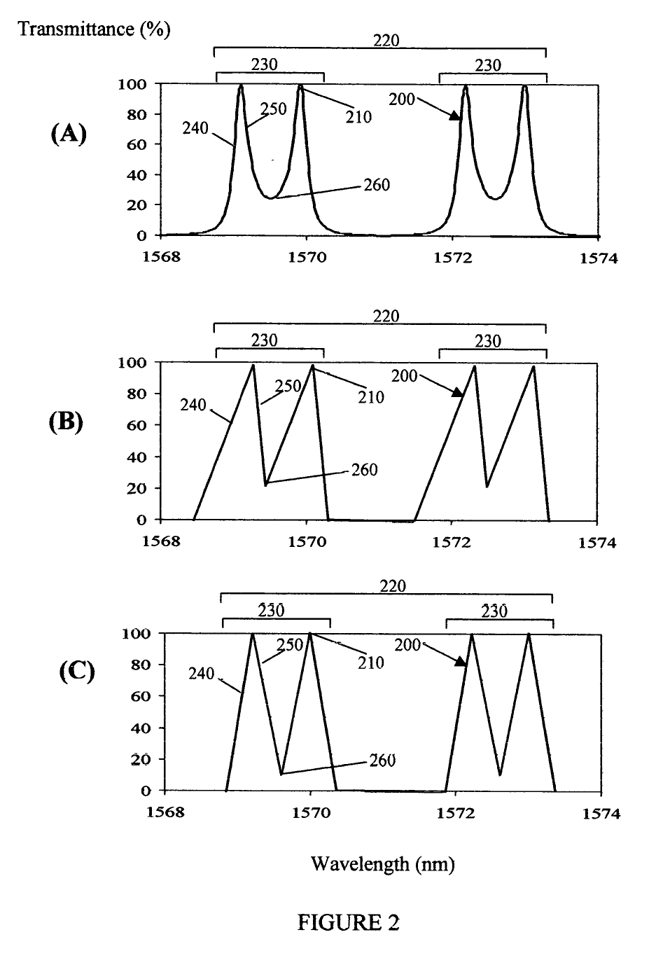

FIGS. 2A, 2B and 2C illustrate exemplary repeating transmission profiles 200 for the stacked dielectric filters of the present invention. Among the common features of these profiles 200 is the presence of at least one peak 210 in transmittance within the operating wavelength range, or spectral range 220, of the filter. The peaks 210 are part of a repeating spectral band 230 that also includes portions of the transmission profile 200 having a positive slope 240, or negative slope 250, as well as portions having troughs 260 in transmittance. It is preferable for the repeating transmission profile characteristics to apply over the entire operable spectral range 220 of the stacked dielectric filter.

Similar to etalons, as illustrated in FIG. 2A, the stacked dielectric filter may have a sinusoidal transmission profile 200. In contrast to etalons, however, it is also possible to prepare stacked dielectric filters having alternative types of transmission profiles 200. For example, illustrated in FIGS. 2B and 2C are substantially sawtooth and substantially triangular profiles 200, respectively.

Transmission profiles 200 such as that illustrated in FIGS. 2B and 2C, and in particular FIG. 2C, are preferred over sinusoidal profiles 200 (FIG. 2A). A triangular transmission profile 200, for example, provides a larger spectral range 220 where the transmittance of light through the filter changes substantially as a linear function of the frequency of light passing through the filter. Unlike a sinusoidal profile 200, triangular, or similar profiles 200, have substantially smaller portions of their spectral range 220 occupied by peaks 210 or troughs 260. As previously discussed, the change in transmittance intensity with wavelength in peaks 210 or trough 260 regions may be insufficient for monitoring and locking the laser's output to the desired wavelength.

It is desirable for the slope 240, 250 in each spectral band 230 to be a substantially linear function of the change in the frequency of light and, preferably, the slope 240, 250 is substantially the same in each spectral band 230. In certain embodiments, it is advantageous for substantial portions of the transmission profiles 200 to have a slope 240, 250 whose absolute value changes by of least about 0.5 percent change in transmittance, per GHz change in the frequency of light emitted by the laser (˜0.5%/GHz). As noted above, the slope may be positive 240 or negative 250, depending on where the wavelength of light of interest falls in the filter's transmission profile.

A repeating transmission profile extends the range of frequencies where the desired slope characteristics are obtained. Thus, it is preferable for each of the spectral bands 230 to have alternating positive and negative slopes 240, 250, as defined by the periodicity in the function defining the transmission profile 200. The number of repeating spectral bands 230 can be as few as two, to as many as possible, with available filter fabrication technology. For example, eight periods of spectral bands 230 separated by about 50 GHz would cover the output range of a typical Distributed Feedback Laser (i.e., laser's range of spectral output equal to about 400 GHz).

It is advantageous for the stacked dielectric filter to have a transmission profile 200 such that the frequency separation between the spectral bands 230 coincide with the standard frequency increments for channels in telecommunication grids. In certain embodiments, for instance, the frequency separation between the spectral bands 230 may coincide with the frequency increment between channels set forth by the International Telecommunication Union (ITU), such as about 25, about 50, about 100 and about 150 GHz increments.

Moreover, it is preferable that the center of the spectral range 220 of the filter's transmission profile 200 is located at about one of the optical bands used in DWDM telecommunication system applications. Adjustments to the operating frequency of the filter may be facilitated by conventional active alignment procedures. In certain preferred embodiments, for example, the spectral range 220 of such filters are centered at one or more of the S bands centered about 1470 nm, or more preferably the C and L bands at about 1550 nm and about 1600 nm optical bands, respectively.

Stacked dielectric filters having a variety of light transmission profiles can be produced, by making particular arrangements of the alternating layers of dielectric material, and by adjusting the thickness of such layers. As further illustrated in the Example section to follow, commercially available computer programs may be used to facilitate the design of the stacked dielectric filter. The stacked dielectric filter may be any combination of dielectric materials that would provide the desired transmission profile. Returning now to FIG. 1, the stacked dielectric filter comprises a stack of alternating layers of a first and second dielectric material, 106, 107, wherein the two different dielectric materials have different refractive indexes at the wavelength of light emitted by the laser.

In certain embodiments, the dielectric materials comprise optical thin films coating a glass substrate. The composition of the dielectric materials and the method for forming such coatings is well known to those of ordinary skill in the art. Preferably, each layer has a thickness equal to a fraction of one-quarter of the wavelength (¼λ) of the laser. In certain advantageous embodiments, for example, the fraction is between about 0.1 and about 4.0 of the ¼λ. {please confirm the technical accuracy of these statements} The difference in refractive indexes between the first and second dielectric materials 106, 107 is preferably at least about 0.6, and more preferably at least about 0.8. {note: this is based on the FILM*STAR users guide V2.24 pp. 6} For example, in certain embodiments, first and second dielectric materials 106, 107 have refractive indexes of about 2.1 and about 1.46, respectively. {please confirm that the refractive index of SiO₂ is 1.46} The dielectric materials 106, 107 may be made of any compounds commonly used to prepare thin film coatings in the optoelectronics industry. In certain embodiments, for example, the first and second dielectric material 106, 107 comprise Ta₂O₅ and SiO₂, respectively.

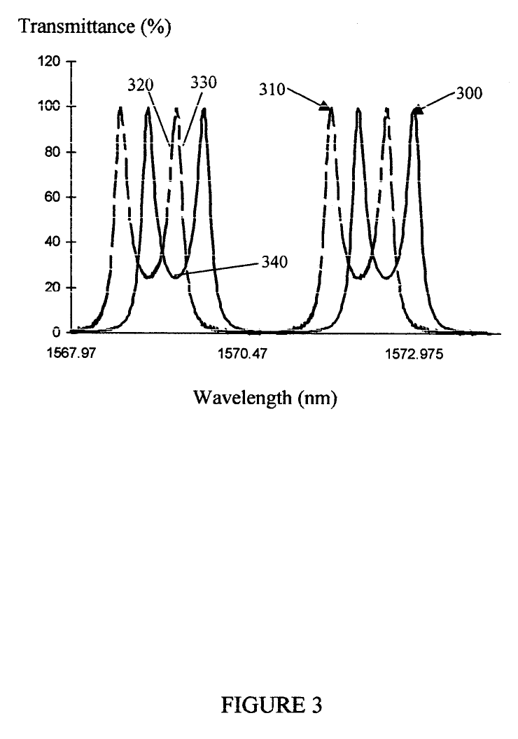

To improve the range of frequencies of light that can be monitored and locked, it is advantageous for the wavelength locking structure to comprise two or more stacked dielectric filters 105, 115. As illustrated in FIG. 3, the stacked dielectric filter may be designed such that the first filter's transmission profile 300 is about 90 degrees out of phase with the second filter's transmission profile 310. For example, as illustrated for filter designs having sinusoidal transmission profiles, the linear portions of the second filter's transmission profile 320, 330 are preferably located at about the trough region 340 of the first filter's transmission profile 310.

The high temperature stability of the periodic stacked dielectric filter improves the wavelength locking package as compared to analogous packages using etalons. In certain preferred embodiments, for example, the transmission profile of the periodic stacked dielectric filter varies by less than about 0.3 picometers per ° C., and more preferably, less than about 0.1 picometers per ° C.

As further illustrated in FIG. 1, the laser 110 may be located within the wavelength locking package 100. In other embodiments, however, the laser 110 may be external to the package 100. In certain preferred embodiments, the laser 110 may be a semiconductor laser, such as a distributed feedback laser. The laser 110 may emit an output light 120 and a sample light 125, either through opposite ends of the laser, as illustrated in FIG. 1, or the same end, as facilitated by conventional beam splitting techniques. The output light 120 may be used for telecommunications or other applications, while the sample light 125 is used for laser monitoring and locking to a particular wavelength, as further described below.

The laser 110 may be bonded to an optical subassembly 130, comprised, for example, of silicon. In certain embodiments, the optical subassembly 130 facilitates thermal coupling and attachment of the laser 110 to a thermal unit 135, such as a thermoelectric cooler. A collimating lens 140 may be situated between the laser 110 and the stacked dielectric filter 105. The lens 140 redirects portions of the sample light 125 to different portions of the stacked dielectric filter 105. In certain embodiments, the sample light 125 passing through the collimating lens 140 is separated into monitored 142 (or 142 & 144) and reference light beams 143. To reduce back reflection to the laser 110, the filter's 105 position is oriented to provide an offset angle 145, for example, between about 1 and about 2 degrees, and preferably 1.5 degrees, from perpendicular to the sample light 125 output from the laser.

A photodetector 150, comprising, for example, p-intrinsic diodes, is optically coupled to the stacked dielectric filter 105. Preferably, the photodetector 150 comprises at least two detectors: a filtered light detector 152 and a reference light detector 153. In certain embodiments, where as illustrated in FIG. 1, there are two stacked dielectric filters 105, 115, the photodetector 150 may further include a third filtered light detector 154 for monitoring light from the second stacked filter 115. The monitored light 152 passes through the stacked dielectric filter 105 and to the filtered light detector portion of the photodetector 152, where a monitoring signal 157 (or 157 & 156) is generated therefrom. The reference light passes directly to the reference light detector portion of the photodetector 153, where a reference signal 158 is generated therefrom.

An output signal from the photodetector 160 is coupled to a thermal controller 170, which, in turn, is coupled to the thermal unit 135. The output signal from the photodetector 160, may comprise both the monitoring and reference signal 157,158 or a combination thereof. The thermal controller 170 analyzes the output signal 160 from the photodetector 150 and determines whether the sampled light's wavelength 125 of the laser has changed. The thermal unit 135 heats or cools the package 100 as directed by the thermal controller 170. If, for example, the ratio of the monitoring signal 157 to the reference signal 158 has changed, then the thermal controller may send a control signal 175 to the thermal unit to heat or cool the wavelength locker package as appropriate to keep laser's output locked to the desired wavelength.

A thermistor 180 records the temperature of the package and thereby provides a signal to the thermal controller 185 to facilitate the temperature control of the package 100. Any or all of the collimator 140, photodetector 150, thermal controller 170, thermal unit 135, or thermistor 180 may be located outside of the package 100. In certain embodiments, however, it may be advantageous for any or all of these components to be in the package, as depicted in FIG. 1.

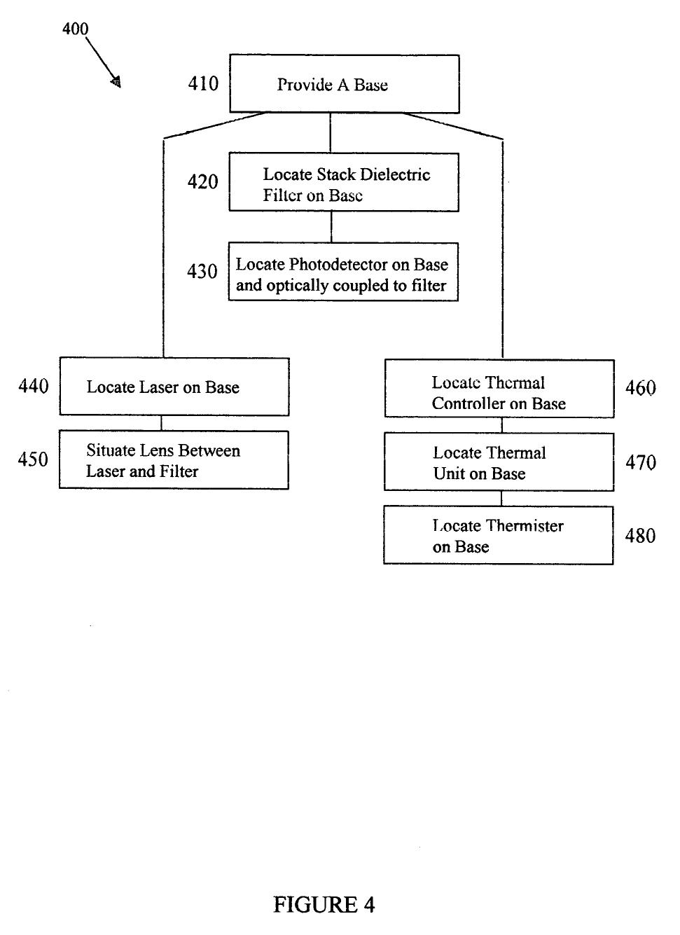

FIG. 4 illustrates by flow diagram, another aspect of the present invention, a method 400 for fabricating a wavelength locking package. The method 400 comprises a step 410 of providing a base. The base may comprise any conventional materials used in the fabrication of optical packages, such as a wavelength locking package. In step 420, a stacked dielectric filter is located on the base. The stacked dielectric filter has a repeating transmission profile that comprises a positive slope and a negative slope. Any of the embodiments of the stacked dielectric filter, discussed herein, may be used in the method 400. In step 430, a photodetector is located on the base material such that the photodetector is optically coupled to the stacked dielectric filter.

The method 400 may further include a number of optional fabrication steps. A laser may be located on the base, in step 440, such that a portion of the laser's output is optically coupled to the stacked dielectric filter. A collimating lens may be located on the base, in step 450, such that the collimating lens is situated between an optical path between the laser and the stacked dielectric filter.

A thermal controller may be located on the base, in step 460, where the thermal controller is capable of receiving a sampling signal from the photodetector. Similarly, a thermal unit may be located in the base, in step 470, where the thermal unit is capable of receiving a control signal from the thermal controller, and thereby heat or cool the package. In step 480, a thermistor may be located on the base where the thermistor is capable of sending a temperature reading to the thermal controller and the thermal controller is capable of using the temperature reading to thereby adjust the control signal.

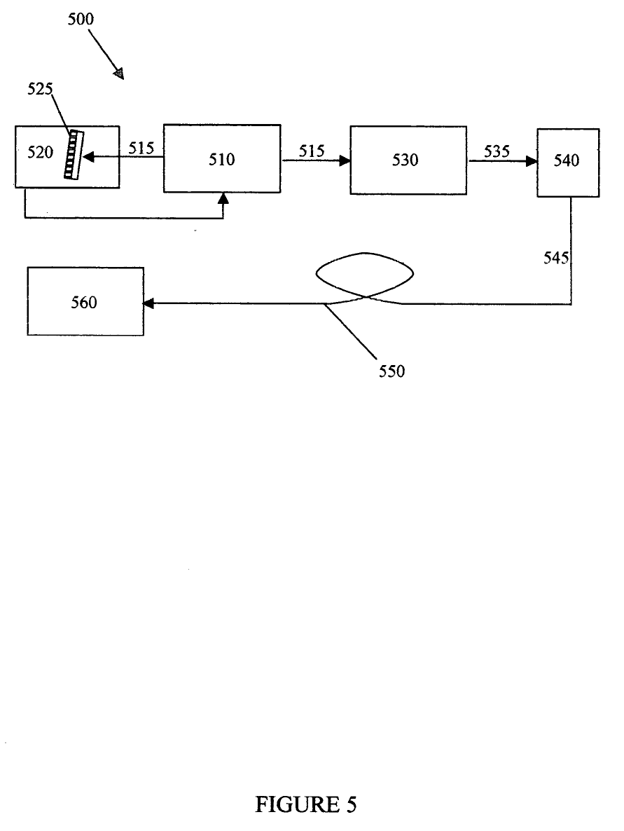

FIG. 5 illustrates a cross-sectional view of yet another embodiment of the present invention, an optoelectronic communication system 500, which may form one environment in which a wavelength locking package 510, made according to the principles of the present invention, may be included. In certain embodiments, for example, the optoelectronic communication system is a DWDM system.

The system 500 comprises a laser 510 capable of emitting coherent light 515 at a plurality of wavelengths. The system also includes a wavelength locking package 520 comprising a stacked dielectric filter 525 having a repeating transmission profile that comprises a positive slope and a negative slope. The stacked dielectric filter 525 is capable of providing a signal to cause the laser 510 to emit the coherent light at one of the pluralities of wavelengths. All embodiments described in the context of the wavelength locking package 100, similar to that shown in FIG. 1, may be equally applied to the package 510 incorporated into the optoelectronic communication system 500.

The system 500 further includes an optical modulator 530 coupled to the laser 510, the modulator 530 being capable of encoding information into the coherent light 535. In certain embodiments, the modulator is an external modulator, that, for example, modulates the coherent light at, for example, frequencies of greater than 2.5 GHz. Alternative modulation schemes, such as direct modulation, where an input signal is coupled to the laser and the laser's output is thereby modulated with communication information at certain frequency, at for example, 2.5 GHz or less, are also within the scope of the present invention.

An optical multiplexer 540 that may be included in the system 500, is coupled to the optical modulator 530. The multiplexer 540 may mix the optical signal with a plurality of coherent light signals of other wavelengths that are also being modulated. The light signal 545, now serving as one of many communication channels in an optical communication grid, may then be coupled to an optical fiber 550, such as a fiber in an optical network that is coupled to the optical multiplexer 540.

A switching station 560 may also be included in the system 500, the station 560 being coupled to the fiber 550. The light signal 545 received by a switching station may, for example, be demultiplexed, information added or subtracted to the signal, and then the modified signal sent back onto the fiber.

Having described the present invention, it is believed that the same will become even more apparent by reference to the following example. It will be appreciated that the example is presented solely for the purpose of illustration and should not be construed as limiting the invention. For instance, although the experiments described below may be carried out in laboratory setting, one of ordinary skill in the art could adjust specific numbers, dimensions and quantities up to appropriate values for a full scale plant.

### EXAMPLES

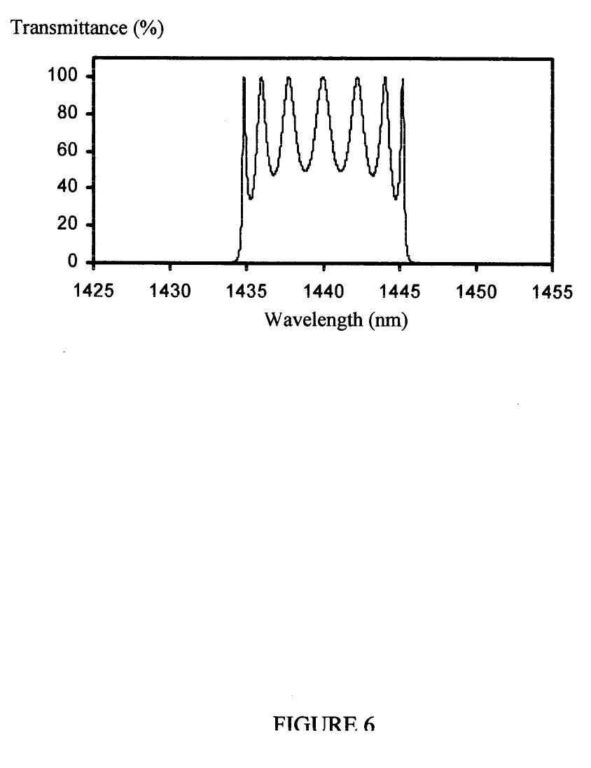

The design for a stacked dielectric filter that could be included in a wavelength locking package of the present invention is illustrated. In particular, a filter design providing sinusoidal transmission profiles having seven peaks, as depicted in FIG. 6, is presented.

A transmission profile defined by a sinusoidal function, similar to that illustrated in FIG. 6, was entered into a thin film filter design software package (FilmStar Optical Thin Film Software Version 2.24; FTG Software Associates, Princeton, N.J.). Using principles well known to those skilled in the art, a computer program in the software package calculated the stacking order and thickness of dielectric materials having refractive indexes of about 2.1 (High RI) and about 1.46 (Low RI), respectively. Such material could correspond to, for example, the refractive indexes of Ta₂O₅ and SiO₂, respectively. The filter was designed to be centered at about 1440 nm and have an operable spectral range of about 10 nm. The seven spectral bands were separated by about 2 nm. {please confirm the technical accuracy of these design parameters and disclose any other input parameters necessary for the software package to produce the output shown in FIG. 6}

The resulting periodic stacked dielectric filter design parameters generated by the computer program for the abovedescribed seven-peak transmission profiles, is shown in TABLE 1. FIG. 6 shows the predicted transmission profile that the stacked dielectric filter would have. {please confirm that these are the correct column designators corresponding to the data presented in the 7 peak etalon replacement excel worksheet}

TABLE 1

| Layer | Material | Thickness | Fraction of ¼ |
|---|---|---|---|
| Number | Type | (nm) | λ thickness |
| 1 | High RI | 169 | 1.00 |
| 2 | Low RI | 251 | 1.00 |
| 3 | High RI | 169 | 1.00 |
| 4 | Low RI | 251 | 1.00 |
| 5 | High RI | 169 | 1.00 |
| 6 | Low RI | 251 | 1.00 |
| 7 | High RI | 169 | 1.00 |
| 8 | Low RI | 251 | 1.00 |
| 9 | High RI | 169 | 1.00 |
| 10 | Low RI | 251 | 1.00 |
| 11 | High RI | 169 | 1.00 |
| 12 | Low RI | 502 | 2.00 |
| 13 | High RI | 169 | 1.00 |
| 14 | Low RI | 251 | 1.00 |
| 15 | High RI | 169 | 1.00 |
| 16 | Low RI | 251 | 1.00 |
| 17 | High RI | 169 | 1.00 |
| 18 | Low RI | 251 | 1.00 |
| 19 | High RI | 169 | 1.00 |
| 20 | Low RI | 251 | 1.00 |
| 21 | High RI | 204 | 1.21 |
| 22 | Low RI | 141 | 0.56 |
| 23 | High RI | 204 | 1.21 |
| 24 | Low RI | 251 | 1.00 |
| 25 | High RI | 169 | 1.00 |
| 26 | Low RI | 251 | 1.00 |
| 27 | High RI | 169 | 1.00 |
| 28 | Low RI | 251 | 1.00 |
| 29 | High RI | 169 | 1.00 |
| 30 | Low RI | 251 | 1.00 |
| 31 | High RI | 169 | 1.00 |
| 32 | Low RI | 502 | 2.00 |
| 33 | High RI | 169 | 1.00 |
| 34 | Low RI | 251 | 1.00 |
| 35 | High RI | 169 | 1.00 |
| 36 | Low RI | 251 | 1.00 |
| 37 | High RI | 169 | 1.00 |
| 38 | Low RI | 251 | 1.00 |
| 39 | High RI | 169 | 1.00 |
| 40 | Low RI | 251 | 1.00 |
| 41 | High RI | 169 | 1.00 |
| 42 | Low RI | 753 | 3.00 |
| 43 | High RI | 169 | 1.00 |
| 44 | Low RI | 251 | 1.00 |
| 45 | High RI | 169 | 1.00 |
| 46 | Low RI | 251 | 1.00 |
| 47 | High RI | 169 | 1.00 |
| 48 | Low RI | 251 | 1.00 |
| 49 | High RI | 169 | 1.00 |
| 50 | Low RI | 251 | 1.00 |
| 51 | High RI | 169 | 1.00 |
| 52 | Low RI | 502 | 2.00 |
| 53 | High RI | 169 | 1.00 |
| 54 | Low RI | 251 | 1.00 |
| 55 | High RI | 169 | 1.00 |
| 56 | Low RI | 251 | 1.00 |
| 57 | High RI | 169 | 1.00 |
| 58 | Low RI | 251 | 1.00 |
| 59 | High RI | 169 | 1.00 |
| 60 | Low RI | 251 | 1.00 |
| 61 | High RI | 169 | 1.00 |
| 62 | Low RI | 753 | 3.00 |
| 63 | High RI | 169 | 1.00 |
| 64 | Low RI | 251 | 1.00 |
| 65 | High RI | 169 | 1.00 |
| 66 | Low RI | 251 | 1.00 |
| 67 | High RI | 169 | 1.00 |
| 68 | Low RI | 251 | 1.00 |
| 69 | High RI | 169 | 1.00 |
| 70 | Low RI | 251 | 1.00 |
| 71 | High RI | 169 | 1.00 |
| 72 | Low RI | 502 | 2.00 |
| 73 | High RI | 169 | 1.00 |
| 74 | Low RI | 251 | 1.00 |
| 75 | High RI | 169 | 1.00 |
| 76 | Low RI | 251 | 1.00 |
| 77 | High RI | 169 | 1.00 |
| 78 | Low RI | 251 | 1.00 |
| 79 | High RI | 169 | 1.00 |
| 80 | Low RI | 251 | 1.00 |
| 81 | High RI | 169 | 1.00 |
| 82 | Low RI | 753 | 3.00 |
| 83 | High RI | 169 | 1.00 |
| 84 | Low RI | 251 | 1.00 |
| 85 | High RI | 169 | 1.00 |
| 86 | Low RI | 251 | 1.00 |
| 87 | High RI | 169 | 1.00 |
| 88 | Low RI | 251 | 1.00 |
| 89 | High RI | 169 | 1.00 |
| 90 | Low RI | 251 | 1.00 |
| 91 | High RI | 169 | 1.00 |
| 92 | Low RI | 502 | 2.00 |
| 93 | High RI | 169 | 1.00 |
| 94 | Low RI | 251 | 1.00 |
| 95 | High RI | 169 | 1.00 |
| 96 | Low RI | 251 | 1.00 |
| 97 | High RI | 169 | 1.00 |
| 98 | Low RI | 251 | 1.00 |
| 99 | High RI | 169 | 1.00 |
| 100 | Low RI | 251 | 1.00 |
| 101 | High RI | 169 | 1.00 |
| 102 | Low RI | 753 | 3.00 |
| 103 | High RI | 169 | 1.00 |
| 104 | Low RI | 251 | 1.00 |
| 105 | High RI | 169 | 1.00 |
| 106 | Low RI | 251 | 1.00 |
| 107 | High RI | 169 | 1.00 |
| 108 | Low RI | 251 | 1.00 |
| 109 | High RI | 169 | 1.00 |
| 110 | Low RI | 251 | 1.00 |
| 111 | High RI | 169 | 1.00 |
| 112 | Low RI | 502 | 2.00 |
| 113 | High RI | 169 | 1.00 |
| 114 | Low RI | 251 | 1.00 |
| 115 | High RI | 169 | 1.00 |
| 116 | Low RI | 251 | 1.00 |
| 117 | High RI | 169 | 1.00 |
| 118 | Low RI | 251 | 1.00 |
| 119 | High RI | 169 | 1.00 |
| 120 | Low RI | 251 | 1.00 |
| 121 | High RI | 204 | 1.21 |
| 122 | Low RI | 141 | 0.56 |
| 123 | High RI | 204 | 1.21 |
| 124 | Low RI | 251 | 1.00 |
| 125 | High RI | 169 | 1.00 |
| 126 | Low RI | 251 | 1.00 |
| 127 | High RI | 169 | 1.00 |
| 128 | Low RI | 251 | 1.00 |
| 129 | High RI | 169 | 1.00 |
| 130 | Low RI | 251 | 1.00 |
| 131 | High RI | 169 | 1.00 |
| 132 | Low RI | 502 | 2.00 |
| 133 | High RI | 169 | 1.00 |
| 134 | Low RI | 251 | 1.00 |
| 135 | High RI | 169 | 1.00 |
| 136 | Low RI | 251 | 1.00 |
| 137 | High RI | 169 | 1.00 |
| 138 | Low RI | 251 | 1.00 |
| 139 | High RI | 169 | 1.00 |
| 140 | Low RI | 251 | 1.00 |
| 141 | High RI | 169 | 1.00 |
| 142 | Low RI | 251 | 1.00 |
| 143 | High RI | 169 | 1.00 |
| 144 | Low RI | 251 | 1.00 |
| 145 | High RI | 235 | 1.39 |
| 146 | Low RI | 50 | 0.20 |
| 147 | High RI | 66 | 0.39 |

One of ordinary skill in the art would understand how to take such design parameters and construct periodic stacked dielectric filters having a transmission profiles substantially similar to the predicted profile shown in FIG. 6, using conventional filter fabrication procedures, and then incorporate such filters into embodiments of the present invention.

Although the present invention has been described in detail, one of ordinary skill in the art should understand that they can make various changes, substitutions and alterations herein without departing from the scope of the invention.

What is claimed is:

1. A wavelength locking package comprising: a stacked dielectric filter having a repeating transmission profile that comprises a positive slope and a negative slope.

2. The wavelength locking package as recited in claim 1, wherein said repeating transmission profile is a substantially sinusoidal function.

3. The wavelength locking package as recited in claim 1, wherein said repeating transmission profile is a substantially triangular function.

4. The wavelength locking package as recited in claim 1, wherein an absolute value of said slope changes by at least about 0.5% transmittance per GHz.

5. The wavelength locking package as recited in claim 1, wherein said repeating transmission profile has spectral bands that are separated by about 25, about 50, about 100, or about 150 GHz.

6. The wavelength locking package as recited in claim 1, wherein said stacked dielectric filter comprises alternating layers of a first and second dielectric material of different refractive index.

7. The wavelength locking package as recited in claim 6, wherein said difference in refractive index between said first and second dielectric material is at least about 0.6.

8. The wavelength locking package as recited in claim 6, wherein said first and second dielectric material comprise Ta₂O₅ and SiO₂, respectively.

9. The wavelength locking package as recited in claim 1, wherein said transmission profile varies by less than about 0.3 picometers per ° C.

10. The wavelength locking package as recited in claim 1, further including a laser capable of emitting coherent light at a plurality of wavelengths.

11. A method of fabricating a wavelength locking package, comprising: providing a base; locating a stacked dielectric filter on said base, said stacked dielectric filter having a repeating transmission profile that comprises a positive slope and a negative slope; and locating a photodetector on said base material such that said photodetector is optically coupled to said stacked dielectric filter.

12. The method as recited in claim 11, further including locating a laser on said base such that a portion of said laser's output is optically coupled to said stacked dielectric filter.

13. The method as recited in claim 12, further including locating a collimating lens on said base, wherein said collimating lens is situated between an optical path between said laser and said stacked dielectric filter.

14. The method as recited in claim 11, further including locating a thermal controller on said base wherein said thermal controller is capable of receiving a sampling signal from said photodetector.

15. The method as recited in claim 11, further including locating a thermal unit on said base wherein said thermal unit is capable of receiving a control signal from said thermal controller and thereby heat or cool said package.

16. The method as recited in claim 11, further including locating a thermistor on said base wherein said thermistor is capable of sending a temperature reading to said thermal controller and said thermal controller is capable of using said temperature reading to thereby adjust said control signal.

17. An optoelectronic communication system comprising: a laser capable of emitting coherent light at a plurality of wavelengths; a wavelength locking package comprising: a stacked dielectric filter having a repeating transmission profile that comprises a positive slope and a negative slope, said stacked dielectric filter capable of providing a signal to cause said laser to emit said coherent light at one of said pluralities of wavelengths; and an optical modulator coupled to said laser, said optical modulator capable of encoding information into said coherent light.

18. The optoelectronic communication system recited in claim 17, further comprising an optical multiplexer coupled to said optical modulator.

19. The optoelectronic communication system recited in claim 17, further comprising a fiber optic network coupled to said optical multiplexer.

20. The optoelectronic communication system recited in claim 17, further comprising a switching station coupled to said fiber optic network.
